(19) United States
(12) Patent Application Publication
(10) Pub. No.: US 2013/0022848 A1
(43) Pub. Date: Jan. 24, 2013

(54) Cell Assembly having a Predetermined Number of Individual Cells which are Electrically Connected Parallel and/or in Series with One Another

(71) Applicants: Dirk Schroeter, Winnenden (DE); Jens Meintschel, Bernsdorf (DE)

(72) Inventors: Dirk Schroeter, Winnenden (DE); Jens Meintschel, Bernsdorf (DE)

(73) Assignee: DAIMIER AG, Stuttgart (DE)

(21) Appl. No.: 13/637,210

(22) PCT Filed: Dec. 8, 2010
(86) PCT No.: PCT/EP2010/007457

§ 371 Date: Sep. 25, 2012

(30) Foreign Application Priority Data
Mar. 26, 2010 (DE) 10 2010 012 936.4

(51) Int. Cl. H01M 10/48

(52) U.S. Cl. 429/90

(57) ABSTRACT

A cell assembly with an integrated force sensing device and a predetermined number of parallel- and/or series-connected individual cells is provided.

### BACKGROUND AND SUMMARY OF THE INVENTION

Exemplary embodiments of the present invention relate to a cell assembly comprising a predetermined number of parallel- and/or series-connected individual cells.

Batteries for vehicle applications, in particular for hybrid applications, consist of a plurality of individual cells connected in series and/or parallel, also known as a cell assembly, which are usually located, together with associated electronics and cooling devices, in a common battery housing. The poles of the individual cells may, for example, be represented directly by housing parts, by conductor lugs connected thereto or by pole contacts, so-called connection terminals.

Under high loading or in overload conditions (e.g., overload or excessively high discharge current, for example in a short-circuit situation), conventional batteries may enter a thermally uncontrollable state when damaged (i.e., in an accident, electrolyte breakdown), or even during normal operation under the influence of strong external heat. In this case they may overheat and build up a dangerous internal pressure (also referred to as cell internal pressure) until the cell and the housing burst or explode, releasing hazardous materials. This risk particularly applies to modern lithium or lithium-ion batteries, because these batteries contain liquid combustible organic electrolytes. In unfavorable conditions these batteries may start to burn and pose a safety-relevant problem. For this reason, safety valves are integrated into conventional batteries for the controlled discharge of excess battery pressure; if these are triggered, they are intended to prevent a fire or a thermal destruction of the battery. Such events would irreversibly damage a conventional battery, which would then have to be replaced.

Exemplary embodiments of the present invention are directed to an improved cell assembly comprising a presettable number of parallel- and/or series-connected individual cells.

In the cell assembly according to the invention, comprising a presettable number of parallel- and/or series-connected individual cells, the invention provides for the integration of a force sensing device into the cell assembly.

The integrated force sensing device ensures that any increase in the cell internal pressure caused by a loading or overloading of the battery is reliably detected.

If the force sensing device detects an increased cell internal pressure, the battery can advantageously be disconnected from the loads and/or from charging electronics.

As a result the battery can be operated more safely and permanently closer to its power limit.

By disconnecting the battery from the loads and/or from charging electronics if an increased cell internal pressure is detected, a fire or an explosion of the battery is reliably avoided. Batteries, in particular lithium or lithium-ion batteries, contain liquid combustible organic electrolytes, which is why these batteries may catch fire if the electrolyte escapes, for example if the battery bursts owing to the increased cell internal pressure.

### BRIEF DESCRIPTION OF THE DRAWING FIGURES

Embodiments of the invention are explained in greater detail with reference to the drawings.

Of the drawings:

FIG. 1 is a diagrammatic perspective view of a cell assembly with a force sensing device;

FIG. 2 is a diagrammatic sectional view of the end face arrangement of the force sensing device;

FIG. 3 is a diagrammatic sectional view of a tie rod and of the Belleville spring assembly; and

FIG. 4 is a diagrammatic sectional view of a cell assembly of pouch cells with a central force sensing device.

Corresponding components are identified by the same reference numbers in all figures.

### DETAILED DESCRIPTION

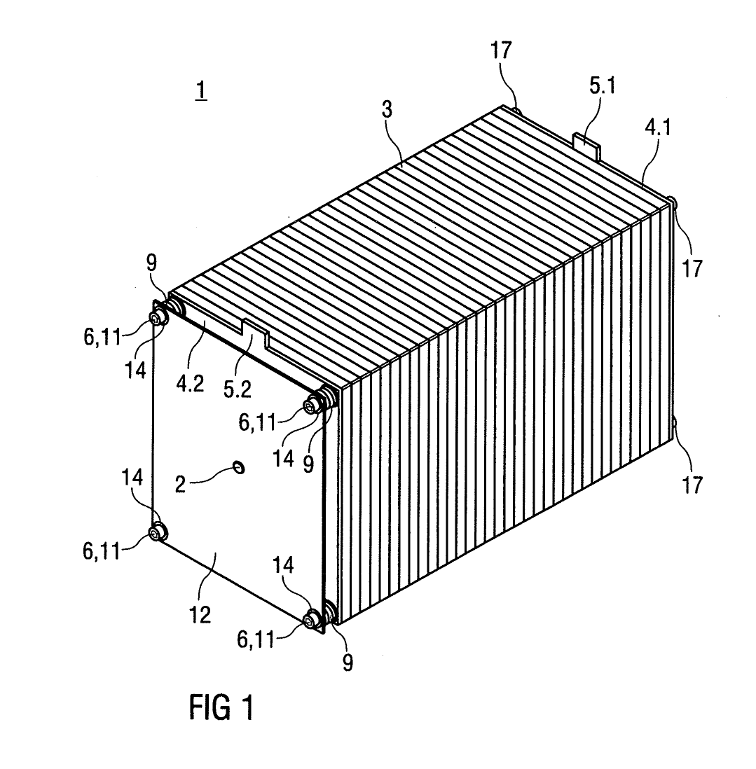

FIG. 1 is a diagrammatic perspective view of the cell assembly 1 with a centrally located force sensing device 2 at its end face.

High-voltage batteries for vehicle applications consist of a plurality of series- and/or parallel-connected individual cells 3 which, together with the associated electronics and cooling facility, are located in a common battery housing. Optimum utilization of the available space can be obtained by using flat cells. To form the cell assembly 1, these are for example arranged side by side.

In one possible embodiment, heat conducting plates are arranged between the individual cells 3.

The individual cells 3 are preferably designed as bipolar frame flat cells.

For the mechanical formation of the cell assembly 1 and for the series-connection of the cells, the bipolar frame flat cells are arranged next to one another. So-called pole plates 4.1 and 4.2 are provided at the end faces of the cell assembly 1.

On each of the pole plates 4.1 and 4.1, an arrester lug is provided as a high-voltage connection 5.1 and 5.2 of the cell assembly 1.

The individual cells 3 between the pole plates 4.1 and 4.2 are pressed together by opposing forces acting on the two pole plates 4.1 and 4.2, the force acting on the pole plate 4.1 being directed towards the pole plate 4.2 and the force acting on the pole plate 4.2 being directed towards the pole plate 4.1.

As a means for generating this force, at least one retaining strap not shown in detail is placed around the cell assembly 1, for example.

A further advantageous embodiment involves the provision of several tie rods 6 in the cell assembly 1.

For this purpose, a cut-out 7 is provided near the edge in each of the four corners of the individual cell 3, which may be square or rectangular. In each individual cell 3 of the cell assembly 1, the cut-outs 7 are placed in the same position, so that, when the individual cells 3 are placed side by side to form the cell assembly 1, the cut-outs 7 of the individual cells 3 are congruent.

With respect to an external circumference of the tie rod 6, the cut-outs are adapted such that one tie rod 6 can be inserted and installed into each of the congruent cut-outs 7.

The pole plates 4.1 and 4.2, which are square or rectangular to match the external dimensions of the individual cells 3, likewise have cut-outs 8 near the edges; these are adapted to an external circumference of the tie rod 6 and congruent with the respective cut-outs 7 of the individual cells 3.

A pressure plate 12 is arranged at one end face of the cell assembly 1. This pressure plate 12 is square or rectangular to match the individual cells 3 and the pole plates 4.1 and 4.2 and has cut-outs 13 near the edges to match an external circumference of the tie rod 6 while being congruent with the cut-outs 7 of the individual cells 3 and the cut-outs 8 of the pole plates 4.1 and 4.2.

In one embodiment, a sleeve 10 is provided in the cut-outs 7 and 8. The cut-outs 7 and 8 are designed to correspond to the external circumference of the sleeve 10, and the internal diameter of the sleeve 10 is enlarged with respect to the external diameter of the tie rod 6, so that the tie rod 6 can be placed in the sleeve 10.

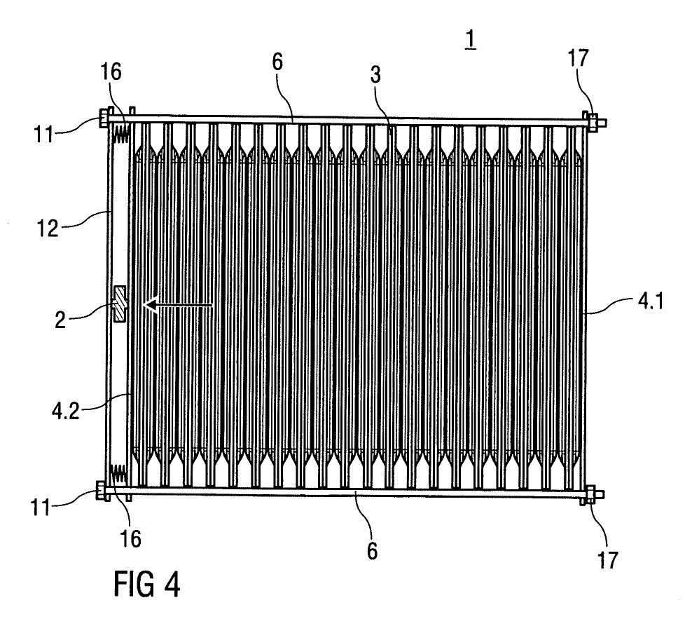

At one of its ends, the tie rod 6 has a conventional screw head 11, for example a hexagon head or a hexagon socket head. At the opposite end, the tie rod 6 is provided with a male thread not shown in detail. This male thread corresponds to a female thread of a conventional nut 17, which is shown in FIG. 4.

In an assembled state of the cell assembly 1, the individual cells 3 are lined up in a congruent arrangement, and the pole plates 4.1 and 4.2 are mounted at the end faces of the cell assembly 1. The pressure plate 12 is fitted to the pole plate 4.2. The tie rods 6 are placed in the congruently arranged cut-outs 7, 8 and 13. The individual cells 3 and the pole plate 4.2 are displaceably held on the tie rods 6. A conventional washer 14 is arranged between the screw head 11 of the tie rod 6 and the pressure plate 12. After the pole plates 4.1 and 4.2, the individual cells 3 and the pressure plate 12 have been installed on the tie rods 6, the conventional nuts 17 are tightened onto the male thread at the end of the tie rods 6. In this way, the cell assembly 1 is compressed and securely held by the four tie rods 6.

Several Belleville springs 9, which may form a Belleville spring assembly on the axis of each of the tie rods 6, allow the axial compression of the individual cells 3. In an assembled state of the cell assembly 1, the individual cells 3 and the pole plates 4.1 and 4.2 are pressed against one another with a defined force by the Belleville springs 9 supported on the pressure plate 12. At the upper and lower ends of the Belleville spring 9 and/or the Belleville spring assembly, centering devices 15 are arranged. One of these two centering devices 15 is located between the pressure plate 12 and the end of the Belleville spring 9 which faces the pressure plate 12, while the other is located between the pole plate 4.2 and the end of the Belleville spring 9 which faces the pole plate 4.2; both are used to centre the Belleville spring 9. The centering device 15 is designed as a washer with a continuous edge, an internal diameter of the continuous edge of the centering device 15 corresponding to an external diameter of the Belleville spring 9, and the continuous edge of the centering device 15 being oriented towards the Belleville spring 9.

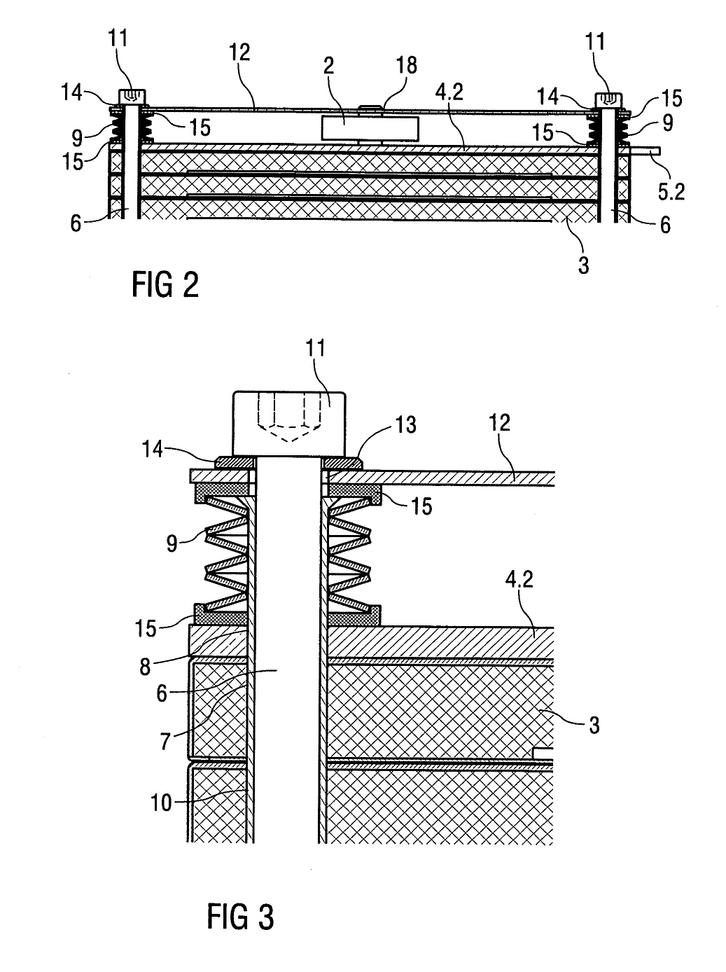

FIG. 2 is a diagrammatic sectional view of the end face arrangement of the force sensing device 2 in the cell assembly 1.

FIG. 3 is a diagrammatic sectional view of the tie rod 6 and of the Belleville springs 9.

In an alternative embodiment of the invention shown in FIG. 4, the Belleville springs 9 are designed as coil springs 16.

If an individual cell 3 is overloaded or short-circuited, an excess pressure is generated in the interior of the individual cell 3. In order to prevent an exothermal chain reaction, also referred to as thermal runaway, and/or an explosion within the individual cell, the excess pressure either has to be dissipated in a controlled manner when reaching a defined limit by opening the individual cell 3, for example by means of a conventional burst opening, or the flow of current into the individual cell 3 and/or the cell assembly 1 has to be interrupted if a defined pressure is exceeded.

The activation of the burst opening of the individual cell 3 results in a destruction of the individual cell 3, which can therefore no longer be used.

To prevent such a destruction of the individual cell 3 and thus of the entire cell assembly 1, a central force sensing device 2 is, according to the invention, integrated into the compressed cell assembly 1. This makes use of the fact that the axial compressive force is identical and known everywhere in the cell assembly 1 and that the axial force in the cell assembly 1 increases if the pressure rises in any individual cell 3 of the cell assembly 1, resulting in outward bulging. When measuring forces, the evaluation electronics (not shown in detail) take account of the preloading of the cell assembly 1 by the Belleville springs 9 and can therefore determine the pressure prevailing in the individual cells 3.

The force sensing device 2 is centrally located at the end face between the pole plate 4.2 and the pressure plate 12. The force sensing device 2 is, for example, designed as a load cell. The pressure plate 12 has a cut-out 18 in which a section of the force sensing device 2 can be accommodated. By this means and by the axial compressive force in the cell assembly 1, the force sensing device 2 is securely held in the cell assembly. 1.

In a manner not shown in detail, the force sensing device 2 is electrically connected to evaluation electronics, which may, for example, be integrated into the battery electronics.

In an alternative embodiment, the force sensing device 2 is designed as a strain gauge not shown in detail. The pressure plate 12 is designed accordingly.

If the cell internal pressure in the cell assembly 1 exceeds a specific value, the battery is disconnected from the loads and/or from charging electronics under the control of the evaluation electronics. As a result, the cell assembly 1 and/or the battery (not shown in detail) can be operated closer to its/their power limit more safely and permanently.

In sum, in the operation of the cell assembly 1, changes in the cell internal pressure of one or more individual cells 3 result in a change in the axial force in the cell assembly 1, because the relatively thin cover plates of the individual cells 3 tend to bulge if there is an excess pressure in the interior of the individual cell 3. This changed axial force in the cell assembly 1 is transmitted to the force sensing device 2 by the pole plate 4.2, measured by the force sensing device 2 and transmitted to the evaluation electronics. If the cell internal pressure of the cell assembly 1 exceeds a presettable value, the battery is disconnected from the loads and/or from charging electronics.

FIG. 4 is a diagrammatic sectional view of an alternative embodiment of the cell assembly 1, which is made of so-called pouch cells, with a central force sensing device 2. In a pouch cell—also known as a coffee bag cell—the electrochemically active cell content is enclosed by a foil.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-5. (canceled)

6. A cell assembly comprising:
a predetermined number of parallel- or series-connected individual cells; and
a force sensing device integrated into the cell assembly.

7. The cell assembly according to claim 6, wherein the force sensing device is a load cell.

8. The cell assembly according to claim 6, wherein the force sensing device is a strain gauge.

9. The cell assembly according to claim 6, wherein the force sensing device is centrally arranged at an end face of the cell assembly.

10. The cell assembly according claim 6, wherein the force sensing device is arranged between a pole plate and a pressure plate.
